(19) United States
(12) Patent Application Publication
(10) Pub. No.: US 2025/0348923 A1
(43) Pub. Date: Nov. 13, 2025

(54) SHOPPING TERMINAL, METHOD, AND STORAGE MEDIUM

(71) Applicant: Toshiba Tec Kabushiki Kaisha, Tokyo (JP)

(72) Inventor: Hiroshi IWASAKI, Susono Shizuoka (JP)

(21) Appl. No.: 19/063,250

(22) Filed: Feb. 25, 2025

(30) Foreign Application Priority Data
May 10, 2024 (JP) 2024-077024

(51) Int. Cl. G06Q 30/0601; G06Q 30/0251

(52) U.S. Cl. CPC G06Q 30/0641; G06Q 30/0252

(57) ABSTRACT

A shopping terminal used in a store includes an input device, an interface circuit connectable to sensors located outside or inside the store, a display, a memory, and a processor configured to execute a program stored in the memory to perform: acquiring sensor data representative of environmental conditions from the sensors through the interface circuit, acquiring first text that is input through the input device, converting each of the sensor data into second text, generating a prompt using the first and second text, inputting the prompt to a computer model, which generates in response thereto third text that promotes an item sold in the store, the computer model being a large language model that has learned relationships and connections between human perceptions under different environmental conditions, and data of items sold in the store, and controlling the display to display the third text.

### CROSS-REFERENCE TO RELATED APPLICATION(S)

This application is based upon and claims the benefit of priority from Japanese Patent Application No. 2024-077024, filed May 10, 2024, the entire contents of which are incorporated herein by reference.

### FIELD

Embodiments described herein relate generally to a shopping terminal, a method, and a storage medium.

### BACKGROUND

In recent years, services utilizing a generative Artificial Intelligence (AI) such as a large language model (LLM) capable of generating natural sentences have appeared. The architecture of such a large language models is called Transformer, which is based on mechanisms called Attention, and is characterized in that the context of conversation can be understood.

Transformer is used to learn the connection of sentence components (i.e., morphemes). For this reason, the numerical values are often replaced with zero in the data used to train the model, except when the numerical values themselves have a universal and unique meaning. For this reason, it is generally considered that a large language model is not good at handling numerical values such as sensor data.

### SUMMARY OF THE INVENTION

Embodiments of the present disclosure provide a shopping terminal, a method, and a storage medium that can obtain answer text in response to an inquiry text, where the answer text reflects environmental information based on data obtained from a sensor.

A shopping terminal that is used in a store, comprises an input device; an interface circuit connectable to one or more sensors located outside or inside the store; a display; a memory; and a processor configured to execute a program that is stored in the memory to perform the steps of: acquiring sensor data representative of environmental conditions from the sensors through the interface circuit, acquiring first text that is input through the input device, converting each of the sensor data into second text, generating a prompt using the first and second text, inputting the prompt to a computer model, which generates in response thereto third text that promotes an item sold in the store, wherein the computer model is a large language model that has learned relationships and connections between human perceptions under different environmental conditions, and data of items sold in the store, and data of items sold in the store, and controlling the display to display the third text.

### BRIEF DESCRIPTION OF THE DRAWINGS

FIG. 1 is a schematic diagram illustrating a configuration of a text generation system according to a first embodiment.

FIG. 2 is a diagram illustrating a hardware configuration of a text generation apparatus according to the first embodiment.

FIG. 3 is a diagram illustrating a data configuration of a label dictionary according to the first embodiment.

FIG. 4 is a functional block diagram illustrating functions performed by the text generation apparatus according to the first embodiment.

FIG. 5 is a diagram illustrating a method for classifying sensor data using threshold values according to the first embodiment.

FIG. 6 is a diagram illustrating class classification by a trained model according to the first embodiment.

FIG. 7 is a flowchart illustrating a flow of a text conversion process of sensor data according to the first embodiment.

FIG. 8 is a flowchart illustrating a flow of an answer process to inquiry text according to the first embodiment.

FIG. 9 is a schematic diagram illustrating a configuration of the text generation system according to a second embodiment.

FIG. 10 is a functional block diagram illustrating functions performed by the text generation apparatus according to the second embodiment.

FIG. 11 is a schematic diagram illustrating a configuration of the text generation system according to a third embodiment.

### DETAILED DESCRIPTION

Hereinafter, embodiments of the present disclosure will be described with reference to the accompanying drawings. Note that the embodiments described below are merely examples, and the configuration, specifications, and the like thereof are not limited thereto.

### First Embodiment

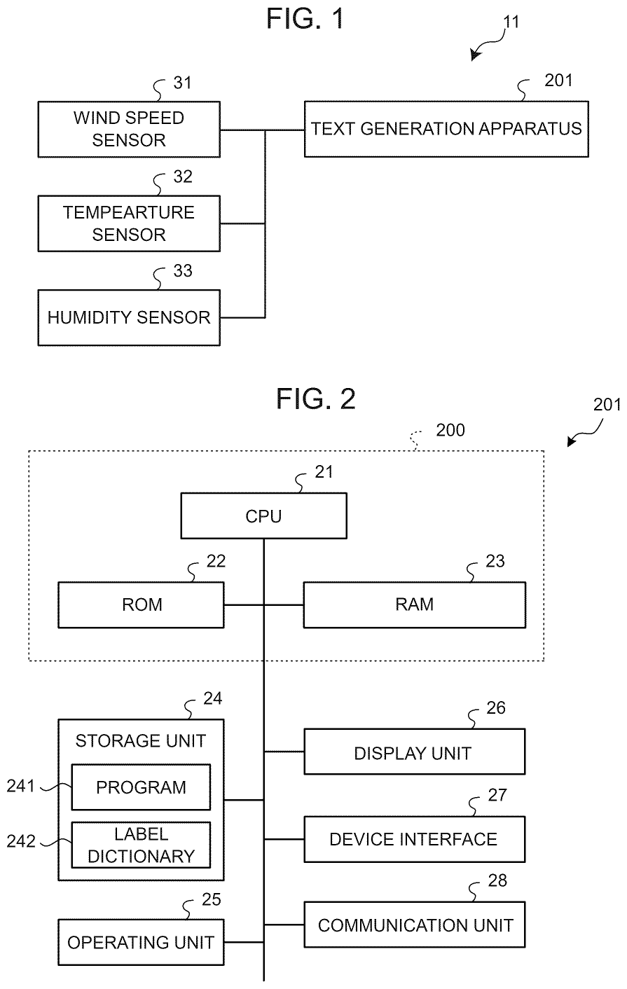

FIG. 1 is a schematic diagram illustrating a configuration of a text generation system 11 according to a first embodiment. The text generation system 11 includes, for example, a text generation apparatus 201 and various sensors 31 to 33. The text generation system 11 is provided in, for example, a store such as a supermarket or a convenience store, and performs a function of making a proposal for a customer such as a food or a recipe. The text generation apparatus 201 and the various sensors 31 to 33 are connected to each other so as to be able to communicate with each other by wire or wirelessly.

The text generation apparatus 201 receives an input of inquiry text from a user, generates answer text for the inquiry text, and outputs the generated answer text. The user in the present embodiment is, for example, a customer of the store. The answer text includes an answer to the inquiry text. The text generation apparatus 201 generates answer text in consideration of the environment information based on the various sensor data acquired from the various sensors 31 to 33. The text generation apparatus 201 may be, for example, a mobile terminal loaned from a store to a customer, a tablet terminal provided in a cart, a kiosk terminal installed in the store, a communication robot, or the like.

In the present embodiment, the text generation apparatus 201 is a single apparatus, but may include a plurality of apparatuses.

The various sensors 31 to 33 are sensors that measure data related to the surrounding environment. Herein, the surrounding environment in the present embodiment is an environment surrounding a user or customer who receives the answer text. Note that the surroundings of the user may include not only the vicinity of the user but also a range such as a user and a region of the store (that is, the store in which the text generation system 11 is provided) where the user is present. For example, the data related to the surrounding environment includes an air temperature, humidity, wind speed, weather, and the like of an area of the store in which the text generation system 11 is provided. The data related to the surrounding environment may further include other elements.

In the present embodiment, the various sensors 31 to 33 are installed outdoors of the store and measure data related to the environment around the store in which the text generation system 11 is provided. In the example illustrated in FIG. 1, a wind speed sensor 31, a temperature sensor 32, and a humidity sensor 33 are shown as examples, but the sensors are not limited thereto. The text generation system 11 may not include all of the wind speed sensor 31, the temperature sensor 32, and the humidity sensor 33. In the present embodiment, the measurement targets of the various sensors 31 to 33 include at least one of wind speed, temperature, and humidity. The various sensors 31 to 33 transmit the measurement results as sensor data to the text generation apparatus 201. The sensor data is numerical data indicating measurement results such as wind speed, temperature, and humidity. The sensor data related to the surrounding environment measured by the various sensors 31 to 33 is also referred to as environmental information indicating the surrounding environment. The sensor data output from the various sensors 31 to 33 may be analog data or digital data.

Next, the configuration of the text generation apparatus 201 described above will be described.

FIG. 2 is a hardware diagram illustrating a configuration of the text generation apparatus 201 according to the present embodiment. As illustrated in FIG. 2, the text generation apparatus 201 includes a central processing unit (CPU) 21, a read only memory (ROM) 22, a random access memory (RAM) 23, a storage unit 24, an operating unit 25, a display unit 26, a device interface 27, a communication unit 28, and the like.

The CPU 21 is a processor and comprehensively controls the operation of the text generation apparatus 201. The ROM 22 stores various programs. The RAM 23 is a workspace for loading programs and various types of data.

The CPU 21, the ROM 22 and the RAM 23 are connected to each other via a bus or the like, and make up a control unit 200. The control unit 200 executes various processes in accordance with the programs stored in the ROM 22 or the storage unit 24 and loaded into the RAM 23.

The storage unit 24 includes a storage device such as a hard disk drive (HDD) or a flash memory, and maintains data and programs even if the power supply is cut off. The storage unit 24 stores a program 241 that can be executed by the CPU 21 and various types of setting data. For example, the program 241 includes a program for realizing a functional configuration described later.

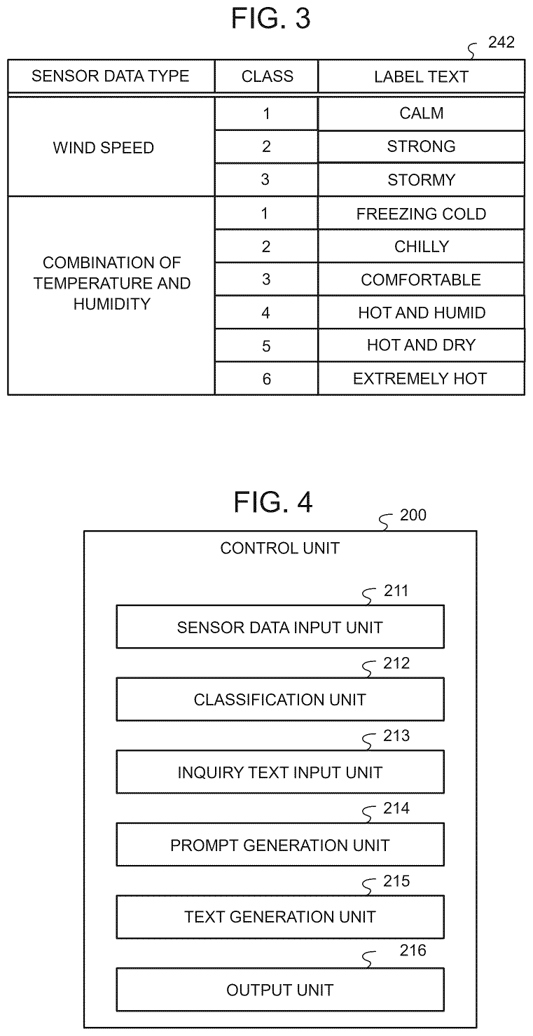

The storage unit 24 stores a label dictionary 242. The label dictionary 242 is a dictionary used to convert sensor data acquired from the various sensors 31 to 33 into label text. The contents of the label dictionary 242 will be described later with reference to FIG. 3.

Note that the above-described data stored in the storage unit 24 is an example, and the storage unit 24 may further store other data. The data stored in the storage unit 24 may be acquired in advance from an external device via a network or the like, or may be input by an administrator or the like.

The operating unit 25 is an input device such as a keyboard or a pointing device. The operating unit 25 outputs the operation content input via the input device to the CPU 21. The operating unit 25 may be a touch panel provided on the display unit 26.

The display unit 26 is a display device such as a liquid crystal display (LCD). The display unit 26 displays various types of data under the control of the CPU 21.

The device interface 27 acquires sensor data from the various sensors 31 to 33. If the sensors 31-33 are outputting analog values, the device interface 27 includes signal-processing circuitry and A/D (analog/digital) converters. When the sensors 31 to 33 have a communication function and transmit the measurement value as digital data to the text generation apparatus 201, the device interface 27 includes a communication interface capable of communicating with the various sensors 31 to 33 by wire or wirelessly. The sensor data acquired by the device interface 27 is transmitted to the control unit 200.

The communication unit 28 is a communication interface circuit such as a network interface controller (NIC) or a wireless network module that can be connected to a network such as the Internet or another information processing apparatus under the control of the control unit 200. When the sensors 31 to 33 have a communication function, the communication unit 28 may also serve as the device interface 27.

Note that the configuration of the text generation apparatus 201 is not limited to the example illustrated in FIG. 2. For example, the text generation apparatus 201 may further include a microphone capable of voice input, a speaker capable of voice output, and the like.

Next, the label dictionary 242 will be described. FIG. 3 is a diagram illustrating a data configuration of the label dictionary 242 according to the present embodiment. As illustrated in FIG. 3, the label dictionary 242 is, for example, a database in which label text corresponding to each of the classes of sensor data is registered for each type of sensor data.

The sensor data type may correspond to sensor data measured by one sensor, or may be a combination of sensor data measured by a plurality of sensors. In the example illustrated in FIG. 3, in the label dictionary 242, two types of sensor data are registered: the wind speed measured by the wind speed sensor 31, and the combination of the air temperature measured by the temperature sensor 32 and the humidity measured by the humidity sensor 33. Note that the sensor data type is not limited to the example illustrated in FIG. 3.

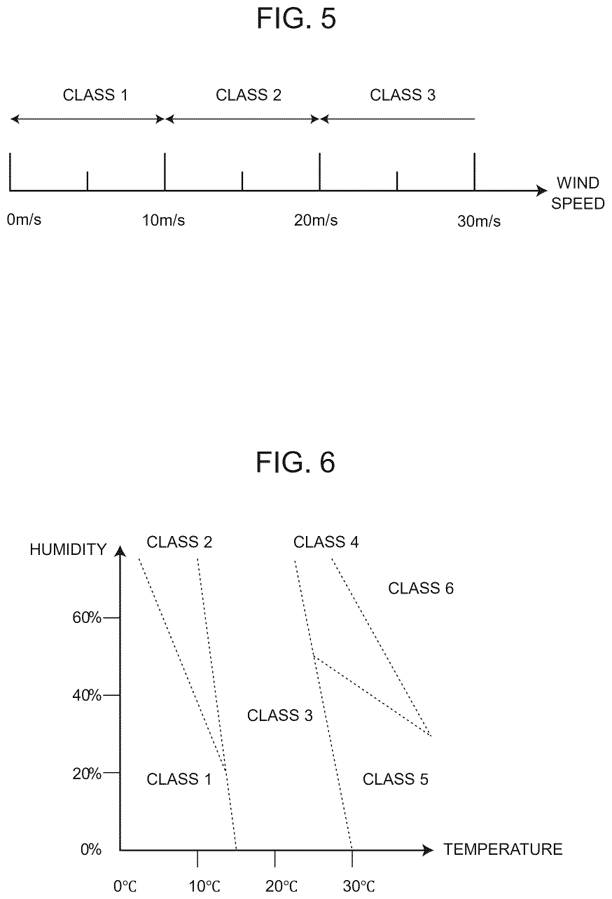

The class of the sensor data is a class in which the sensor data is classified according to the value of the acquired sensor data. The classification of the sensor data will be described later with reference to FIGS. 5 and 6.

For each class in which sensor data is classified, different label texts are associated with each other. The label text is text including a qualitative representation of a state indicated by the sensor data. For example, in the example illustrated in FIG. 3, the value of the wind speed measured by the wind speed sensor 31 is classified into any of the classes 1 to 3, and the label texts “calm”, “strong”, and “stormy” are associated with the classes 1 to 3, respectively. Further, the combined result of the air temperature measured by the temperature sensor 32 and the humidity measured by the humidity sensor 33 is classified into any of the classes 1 to 6, and label texts of “freezing cold”, “chilly”, “comfortable”, “hot and humid”, “hot and dry” and “extremely hot” are associated with the classes 1 to 6, respectively. In other words, the label text describes the environmental information corresponding to the values of the sensor data classified into the respective classes.

In addition, since the label text is intended to convert numerical data into text, the label text itself does not include any numerical value.

In FIG. 3, the class and the label text are associated with each other in a one-to-one manner, but a plurality of label texts may be associated with one class. Further, although the label text of the sensor data of different types is registered in one table in FIG. 3, the label dictionary 242 may be constituted by a plurality of tables in which the label text of each type of the sensor data is registered.

Next, the function of the text generation apparatus 201 will be described. FIG. 4 is a functional block diagram illustrating functions performed by the control unit 200 of the text generation apparatus 201 according to the present embodiment. The text generation apparatus 201 performs the functions of a sensor data input unit 211, a classification unit 212, an inquiry text input unit 213, a prompt generation unit 214, a text generation unit 215, and an output unit 216 in accordance with the program 241 stored in the storage unit 24, as illustrated in FIG. 4. More specifically, the program 241 executed by the text generation apparatus 201 of the present embodiment has a module configuration including the above-described units (i.e., the sensor data input unit 211, the classification unit 212, the inquiry text input unit 213, the prompt generation unit 214, the text generation unit 215, and the output unit 216). The CPU 21 reads the program 241 from a storage medium such as the storage unit 24, and loads the program modules or the like of the above-described units onto the RAM 23. Note that these functional units are merely examples, and the text generation apparatus 201 may further perform other functions.

The program 241 of the present embodiment may be stored in the storage unit 24 in advance, or may be stored on another computer connected to a network such as the Internet and provided by being downloaded to the text generation apparatus 201 via the network. Further, the program 241 executed by the text generation apparatus 201 of the present embodiment may be provided or distributed via a network such as the Internet. The program 241 executed by the text generation apparatus 201 of the present embodiment may be recorded in a computer-readable recording medium in an installable format or an executable format file. In addition, some or all of the functional configurations included in the text generation apparatus 201 may be hardware configurations realized by a dedicated circuit or the like mounted on the text generation apparatus 201.

The sensor data input unit 211 acquires sensor data from the various sensors 31 to 33.

The classification unit 212 classifies the input sensor data into one of a plurality of classes for each type of sensor data. More specifically, the classifying unit 212 classifies the sensor data acquired from the various sensors 31 to 33 by a preset algorithm. As a classification method, a method of classifying numerical data acquired as sensor data by a threshold value or a method of classifying numerical data acquired as sensor data by a trained model of machine learning can be adopted.

FIG. 5 is a diagram illustrating a method of classifying sensor data by thresholds according to the present embodiment. In FIG. 5, the wind speed is taken as an example of the type of sensor data. The classifying unit 212 classifies the measured numerical value of the wind speed into the class 1 when the value is equal to or greater than 0 m/s and less than 10 m/s, the class 2 when the value is equal to or greater than 10 m/s and less than 20 m/s, and the class 3 when the value is equal to or greater than 20 m/s. The classes used for the classification correspond to the classes 1 to 3 of the sensor data type “wind speed” registered in the label dictionary 242 described with reference to FIG. 3.

FIG. 6 is a diagram illustrating an example of class classification based on a trained model of machine learning according to the present embodiment. In FIG. 6, a combination of temperature and humidity is exemplified as an example of the type of sensor data. In the example illustrated in FIG. 6, the combination of the temperature and the humidity is classified into six classes by a trained model that learns the relationship between the combination of the temperature and the humidity and the heat and cold experienced by the human from its training data. The classes used for the classification correspond to the classes 1 to 6 of the sensor data type “combination of temperature and humidity” registered in the label dictionary 242 described with reference to FIG. 3.

Note that the classification unit 212 may acquire the result of the class classification by inputting the sensor data to the trained model at the time of operation, or may determine a threshold based on the output result of the trained model, and the classification unit 212 may classify the sensor data of the air temperature and the humidity based on the threshold. Note that the label text registered in the label dictionary 242 may also be output in advance by a trained model that learns the relationship between the combination of the temperature and the humidity and the heat and cold experienced by the human from its training data. Note that the number of classes in which the sensor data is classified is not limited to the above-described example.

Returning to FIG. 4, the inquiry text input unit 213 receives inquiry text input by the user. More specifically, the inquiry text input unit 213 acquires the inquiry text input by the user's operation from the operating unit 25. For example, when the operating unit 25 is a touch panel, an input field that can be input by a touch operation may be displayed on the display unit 26 by an output unit 216, which will be described later, and inquiry text may be input to the input field by a user's operation. The inquiry text input unit 213 is not particularly limited, and may be voice input by a microphone or the like.

The inquiry text is text including a question for which the user requests an answer from the text generation apparatus 201. For example, in a case where the text generation apparatus 201 is installed in a supermarket or the like for the purpose of making a proposal such as a menu or a foodstuff, a shopper inputs inquiry text including a question about a menu or a foodstuff as a user. As an example of the inquiry text, the text “What is recommended for an appetizer served with drinks tonight?” is cited.

The prompt generation unit 214 generates a prompt based on the input inquiry text and the label text corresponding to the sensor data.

The prompts are statements that can be entered into a large language model. In general, in a large language model, a sentence close to a natural language can be input. Note that the large language model used in the present embodiment is an exemplary generative AI.

The prompt generation unit 214 of the present embodiment generates a prompt by combining label text corresponding to the sensor data of the various sensors 31 to 33 input by the sensor data input unit 211 with the inquiry text, instead of using the input inquiry text as a prompt. More specifically, the prompt generation unit 214 generates a prompt using the label text corresponding to the class in which the input sensor data is classified by the classification unit 212.

For example, it is assumed that the wind speed input from the wind speed sensor 31 is classified into the class “3” by the classification unit 212. In the label dictionary 242 illustrated in FIG. 3, the label text associated with the wind speed class “3” is “stormy”. Further, it is assumed that the atmospheric temperature input from the temperature sensor 32 and the humidity input from the humidity sensor 33 are classified into the class “1” by the classification unit 212. In the label dictionary 242 illustrated in FIG. 3, the label text associated with the class “1” of the combination of temperature and humidity is “freezing cold”. The prompt generation unit 214 acquires the label text corresponding to the class in which these pieces of sensor data are classified from the label dictionary 242, and combines the obtained label text with the input inquiry text, for example, generates a prompt of “Today is freezing cold, and the wind is stormy. What is recommended for an appetizer served with drinks tonight?” As described above, the text generation unit 215, which will be described later, inputs the prompt in which the label text corresponding to the sensor data is incorporated into the large language model, so that it is expected that an answer more suitable for the current situation can be obtained.

In other words, the prompt generation unit 214 converts sensor data, which is numerical data, into label text, which is text data including a quantitative expression, and then incorporates the label text into the prompt. This is because, in general, a large language model is not good at handling numerical values such as sensor data, and therefore, even if the numerical values of the sensor data are directly incorporated into a prompt, responses appropriately corresponding to the meaning indicated by the numerical values (for example, the degree of cold experienced by a person in the case of temperature and humidity) may not be obtained in some cases. The reason why large language models are not good at dealing with numerical values is that since Transformer used in many large language models is a model that learns the connections of the constituent elements (i.e., morphemes) of sentences, the numerical numbers are often replaced with zero in the data used for training the model, except when the numerical values themselves have a universal and unique meaning.

The text generation unit 215 generates text including an answer to the inquiry text by inputting the prompt generated by the prompt generation unit 214 into the large language model. The large language model may be stored, for example, in the storage unit 24 or may be stored in an external device capable of communicating with the text generation apparatus 201 via a network or the like.

For example, in the large language model, when you receive the prompt “Today is freezing cold, and the wind is stormy. What is recommended for an appetizer served with drinks tonight?”, the prompt “How is hot tofu? It tastes great in hot winter days, enjoying the flavor of soybeans and the gorgeous aroma of hot sake.” or “How about ajillo? Oysters are good ingredients for the current season. Pairing it with wine will make you feel rich.” The answer text reflecting the environment represented by the label text included in the input prompt is output. In the above-described example, the answer text of the large language model does not simply answer “appetizer”, but answers “appetizer” corresponding to the state of the environment expressed by the label text of “stormy” and “freezing cold”. These answer texts are merely examples, and the content and the wording of the answer text are not limited thereto.

The large language model used in the present embodiment is, for example, a model called Transformer composed of mechanisms called Attention, and when a prompt is input, an answer to the prompt is output in text. The large language model is, for example, a trained large language model publicly available to the public by an enterprise or a research institution, and is operable in an environment of a store or an enterprise using the text generation system 11. In addition, the large language model is trained by a data set composed of various sentences in order to be able to cope with various applications. In addition, the large language model may be further subjected to fine-tuning specialized for use by a store or an enterprise using the text generation system 11. Fine tuning may change the content of an answer to an input prompt or may change the wording of a sentence to be output. For example, the large language model used in the present embodiment may have been trained using a specific phrase such as a tone of a character of a store or a company using the text generation system 11 or an ending word.

The output unit 216 outputs the text including the answer to the inquiry text generated by the text generation unit 215 (i.e., answer text). For example, the output unit 216 displays the text output from the large language model on the display unit 26. As a result, the user who has input the inquiry text can confirm the answer to the inquiry text.

Note that the method of outputting the answer text is not limited to the display on the display unit 26. For example, the answer text may be audibly output by the speaker.

Further, the output unit 216 may display the inquiry text input screen on the display unit 26.

Next, a flow of processing executed by the text generation apparatus 201 configured as described above will be described.

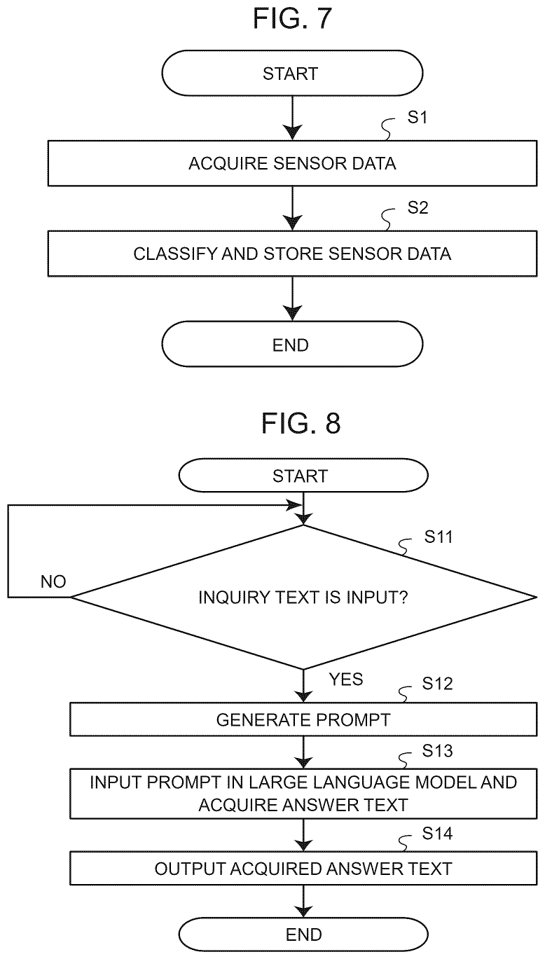

FIG. 7 is a flowchart illustrating a flow of a text conversion process of sensor data according to the present embodiment.

First, the sensor data input unit 211 acquires sensor data from the various sensors 31 to 33 (S1).

Next, the classification unit 212 classifies the sensor data acquired by S1 into one of a plurality of classes for each type of the sensor data, and stores the classification data in, for example, the storage unit 24 (S2). Here, the processing of this flowchart ends.

The processing illustrated in FIG. 7 is executed periodically, and the class indicating the classification result of the sensor data stored in the storage unit 24 is updated. The frequency of execution of the processing is not particularly limited, but it is assumed that the processing is executed at least once a day, for example, in order to cope with a change in the surrounding environment (for example, a change in weather). The higher the acquisition frequency of the sensor data, the more real-time environment-reflecting answer text can be generated. In addition, the acquisition frequency and acquisition timing of the sensor data may be different depending on the types of the various sensors 31 to 33.

Although the class corresponding to the classification result of the sensor data is stored in FIG. 7, the label text corresponding to the class may be stored in the storage unit 24. Alternatively, a numerical value of the acquired sensor data may be stored in the storage unit 24.

Next, the flow of the answer processing to the inquiry text input by the user will be described. FIG. 8 is a flowchart illustrating a flow of an answer process in response to an inquiry text according to the present embodiment. It is assumed that the processing illustrated in FIG. 7 has been executed at least once before the start of the processing illustrated in FIG. 8.

First, it is assumed that the inquiry text input unit 213 receives inquiry text input by the user (S11: Yes). In this case, the prompt generation unit 214 generates a prompt based on the inquiry text input by S1 and the label text corresponding to the class in which the sensor data stored in the storage unit 24 in the process of FIG. 7 is classified (S12). For example, the prompt generation unit 214 acquires the label text corresponding to the class in which the latest sensor data stored in the storage unit 24 is classified from the label dictionary 242, and generates a prompt in consideration of the surrounding environment by combining the acquired label text with the inquiry text.

Next, the text generation unit 215 inputs the prompt generated by the prompt generation unit 214 into the large language model, and acquires the answer text output from the large language model (S13).

Then, the output unit 216 outputs the acquired answer text by, for example, displaying the answer text on the display unit 26 (S14). Here, the processing of this flowchart ends.

As described above, according to the text generation apparatus 201 of the present embodiment, by outputting the generated text by inputting the prompt generated based on the inquiry text input by the user and the label text corresponding to the sensor data related to the surrounding environment into the large language model, it is possible to obtain the answer text reflecting the environment information based on the sensor data obtained from the various sensors 31 to 33 with respect to the inquiry text.

As described above, in general, a large language model is not good at handling numerical values such as sensor data, and therefore, even if the numerical values of the sensor data are directly incorporated into a prompt, an answer corresponding appropriately to the meaning indicated by the numerical values may not be obtained. On the other hand, the text generation apparatus 201 of the present embodiment does not use the numerical value of the sensor data as it is, but converts it into label text and incorporates it into a prompt, so that the meaning indicated by the sensor data can be reflected in the prompt. Further, the text generation apparatus 201 of the present embodiment generates a prompt by combining the label text corresponding to the sensor data with the inquiry text, instead of using the input inquiry text as the prompt. Therefore, according to the text generation apparatus 201 of the present embodiment, it is expected that an answer suitable for the current situation can be obtained rather than using the input inquiry text as it is.

Further, the text generation apparatus 201 of the present embodiment classifies the sensor data into any of a plurality of classes for each type of sensor data, and acquires the label text to be incorporated in the prompt by the label dictionary 242 in which the label text corresponding to each classification is registered. A slight difference in the numerical values of the sensor data may not substantially change as a human-perceived environment. Therefore, the text generation apparatus 201 according to the present embodiment classifies the sensor data and associates the classified data with the label text, thereby avoiding subdividing the processing more than necessary and reflecting the difference in the environment information on the prompt with appropriate accuracy.

Further, the text generation apparatus 201 of the present embodiment classifies sensor data, which is numerical data, into one of a plurality of classes by a threshold value or a trained model of machine learning for each type of sensor data. Therefore, according to the text generation apparatus 201 of the present embodiment, it is possible to adopt an appropriate classification method according to the type of sensor data.

Further, the text generation apparatus 201 of the present embodiment stores a label dictionary 242 in which label text including a qualitative expression related to sensor data corresponding to each of a plurality of classes is registered for each type of sensor data. The label dictionary 242 can convert sensor data, which is numerical data, into text describing environmental information corresponding to values of sensor data classified into respective classes.

### Second Embodiment

In the first embodiment described above, the wind speed sensor 31, the temperature sensor 32, and the humidity sensor 33 are exemplified, but the sensor may be a camera capable of capturing an image.

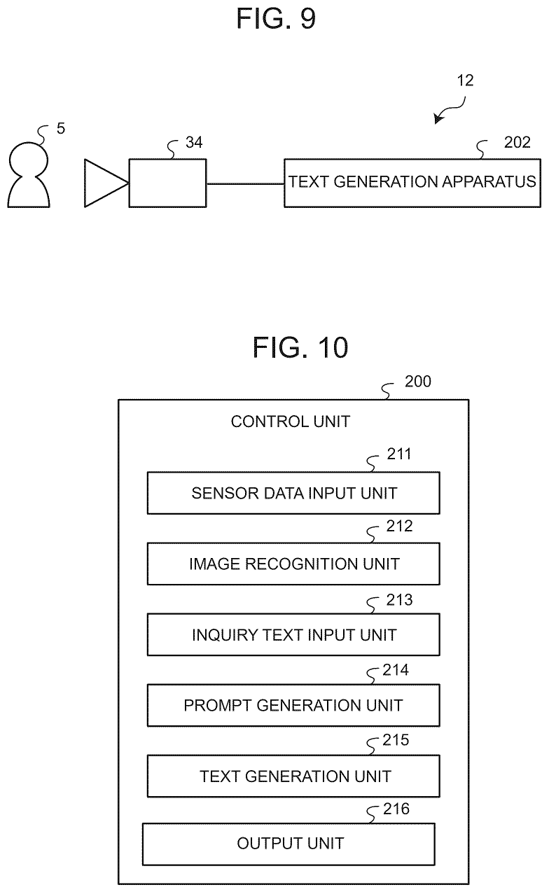

FIG. 9 is a schematic diagram illustrating a configuration of a text generation system 12 according to a second embodiment. As illustrated in FIG. 9, the text generation system 12 of the present embodiment includes, for example, a text generation apparatus 202 and a camera 34.

The camera 34 is communicably connected to the text generation apparatus 202 by wire or wirelessly. Alternatively, the camera 34 may be mounted on the text generation apparatus 202. The camera 34 is, for example, a camera mounted on a terminal held by a user's hand, a camera mounted on a cart on which a tablet terminal is mounted, a camera mounted on a kiosk terminal installed in a store, a camera mounted on a communication robot, or the like. The terminal held in the hand by the user is, for example, a smartphone carried by the user or a mobile terminal loaned from a store to the user. When the smartphone carried by the user is used as the camera 34, an application capable of communicating with the text generation system 12 is installed in the smartphone in advance.

The camera 34 captures an image of the environment around the user 5 and the user 5, which is a customer of the store or the like. The image captured by the camera 34 may be a still image or a moving image. In the present embodiment, an image captured by the camera 34 is an example of sensor data. In addition, in the present embodiment, the surrounding environment includes an attribute or a state of the user 5 himself/herself, and a situation in the vicinity of the user 5 included in the angle of view of the camera 34. The attributes of the user 5 are, for example, gender, age, and the like. The attribute of the user 5 is, for example, the facial expression (e.g., anger, laughter, etc.) of the user 5. The situation in the vicinity of the user 5 included in the angle of view of the camera 34 includes information on the illuminance or the time zone of the shooting location, such as “light”, “dark”, “light”, and “evening”, based on the brightness or color of the image, for example. In addition, in a case where a window is included in the angle of view of the camera 34, information indicating “good weather” or “bad weather” may be included in the situation in the vicinity of the user 5 from the estimation result regarding the brightness of the window, the season at the time of shooting, and whether the weather based on the shooting time is clear, cloudy, or rainy. Further, as another example, the situation in the vicinity of the user 5 may include a congestion situation in the store such as “empty”, “crowded”, “sparse human street”, and “many human streets” from the number of persons in the field angle of the camera 34. The attribute or state of the user 5 itself based on the captured image and the situation in the vicinity of the user 5 are recognized by an image recognition unit 217 which will be described later.

The hardware configuration of the text generation apparatus 202 is the same as that of the first embodiment. When the text generation apparatus 202 includes the camera 34, the hardware configuration includes the camera 34.

FIG. 10 is a functional block diagram illustrating functions performed by the control unit 200 of the text generation apparatus 202 according to the present embodiment. The text generation apparatus 202 performs the functions of the sensor data input unit 211, the image recognition unit 217, the inquiry text input unit 213, the prompt generation unit 214, the text generation unit 215, and the output unit 216 by the control unit 200 operating in accordance with the program 241 stored in the storage unit 24, as illustrated in FIG. 10.

The sensor data input unit 211 of the present embodiment acquires an image from the camera 34. Note that the sensor data input unit 211 may acquire an image from the camera 34 when the user 5 performs an operation to input inquiry text, or may acquire an image from the camera 34 before the user 5 operates.

The image recognition unit 217 recognizes the surrounding environment from the image acquired from the camera 34 by image recognition, and acquires the label text corresponding to the recognition result. The image recognition unit 217 may be, for example, an image recognition system including a trained model configured by AI technology. The image recognition unit 217 generates text representing the environment around the user 5 and the user 5 from the image acquired from the camera 34. The text is a label text in the present embodiment. The image recognition unit 217 may select the label text from the label dictionary 242, or may generate the label text from the trained model in which the image and the label text are learned. When the label text is generated by the trained model, the storage unit 24 of the present embodiment may not store the label dictionary 242.

The text representing the user 5 is, for example, text representing an attribute (e.g., gender, age), a state (expression, etc.) of the user 5, or the like. The image recognition unit 217 estimates the attribute, status, and environment around the user 5 of the user 5 from the image acquired from the camera 34, and generates a word representing the estimation result as label text. Note that the age may be not a numerical value, but a term representing an age group such as “child”, “young”, “middle age”, and “old age” may be used. The model learns how to generate such text from training data that includes multiple images of human faces and label text of the multiple images.

As in the first embodiment, the inquiry text input unit 213 acquires the inquiry text input by the user 5. In the present embodiment, when the camera 34 is provided separately from the text generation apparatus 202, the inquiry text input unit 213 may acquire the inquiry text input by the user 5 to the terminal from the same terminal as the camera 34 (e.g., a terminal held by the user 5 in the hand or a tablet terminal installed in a cart or the like). Alternatively, the inquiry text input unit 213 may acquire the inquiry text by voice input by a headset (such as an earphone with a microphone) wirelessly connected to the terminal.

The functions of the prompt generation unit 214 and the text generation unit 215 are the same as those of the first embodiment described above.

Further, the output unit 216 displays the text output from the large language model on the display unit 26 of the text generation apparatus 202 as in the above-described first embodiment. Alternatively, the output unit 216 may output the answer text by voice through a speaker of the text generation apparatus 202. When the camera 34 is provided separately from the text generation apparatus 202, the output unit 216 may transmit the answer text to the same terminal as the camera 34. In this case, the answer text is output from the terminal by screen display or voice.

As described above, according to the text generation apparatus 202 of the present embodiment, in addition to the effects of the above-described first embodiment, it is possible to generate answer text corresponding to a scene or a situation recognized from an attribute of the user 5 captured by the camera 34 or a configuration of an object within an angle of view of the camera 34.

### Third Embodiment

In the above-described first embodiment, the single text generation apparatus 201 has a function of accepting input of inquiry text by the user 5 and a function of presenting answer text to the user 5 in addition to a function of generating answer text, but these functions may be realized by other devices.

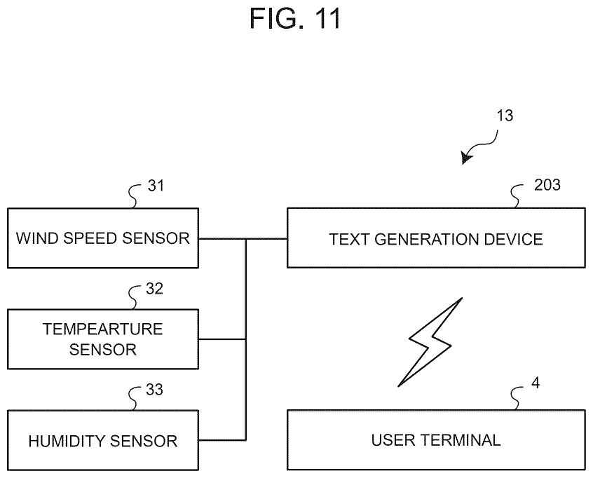

FIG. 11 is a schematic diagram illustrating a configuration of the text generation system 13 according to a third embodiment. As illustrated in FIG. 11, the text generation system 13 of the present embodiment includes, for example, a text generation apparatus 203, various sensors 31 to 33, and a user terminal 4.

The text generation apparatus 203 and the user terminal 4 are communicably connected by short-range radio communication such as Wi-Fi (registered trademark) in a store, for example. The text generation apparatus 203 receives inquiry text from the user terminal 4, generates answer text for the inquiry text, and transmits the generated answer text to the user terminal 4. In the present embodiment, the text-generating device 203 is, for example, a server device, but may be a kiosk terminal or a personal computer (PC) installed in a store, or another computer.

The user terminal 4 only needs to have a function of accepting an operation by the user 5 and a function of presenting information to the user 5, and various devices can be employed. As an example, the user terminal 4 may be a smartphone of a user, a mobile terminal lent from a store to a customer, a tablet terminal provided in a cart, a kiosk terminal installed in a store, a communication robot, or the like. When the smartphone carried by the user 5 is used as the user terminal 4, an application capable of communicating with the text generation system 13 is installed in the smartphone in advance.

The user terminal 4 receives the inquiry text input by the operation of the customer who is the user 5, and transmits the inquiry text to the text generation apparatus 203. Further, the user terminal 4 receives answer text to the inquiry text from the text generation apparatus 203, and outputs the received answer text.

The hardware configuration of the text generation apparatus 203 is the same as that of the first embodiment. As in FIG. 4, the functional configuration of the text generation apparatus 203 includes a sensor data input unit 211, a classification unit 212, an inquiry text input unit 213, a prompt generation unit 214, a text generation unit 215, and an output unit 216.

The inquiry text input unit 213 of the present embodiment acquires the inquiry text input to the user terminal 4 by the user from the user terminal 4 via the communication unit 28.

Further, the output unit 216 of the present embodiment outputs the answer text to the inquiry text generated by the text generation unit 215 from the communication unit 28 to the user terminal 4.

The functions of the sensor data input unit 211, the classification unit 212, the prompt generation unit 214, and the text generation unit 215 of the present embodiment are the same as those of the first embodiment.

As described above, since the user terminal 4 and the text generation apparatus 203 that perform the function of the user interface are configured as separate apparatuses, the text generation system 13 can provide services to the user 5 in various forms.

### Modification

Note that the first embodiment and the second embodiment described above, or the second embodiment and the third embodiment can be combined. That is, both the various sensors 31 to 33 and the camera 34 may be used.

Further, in each of the above-described embodiments, the text generation systems 11 to 13 are provided in stores such as supermarkets and convenience stores, and the functions are provided to customers for the purpose of making proposals such as menus and foods. However, the use scenes of the text generation systems 11 to 13 are not limited thereto. For example, the text generation systems 11 to 13 can also be used in a back office to facilitate order placement of a commodity to a store clerk of a store, a layout of a commodity display, and the like.

The text generation systems 11 to 13 can also be incorporated into home appliances and car navigation systems (e.g., IoT (Internet of Things)). Applications to IoT home appliances include air conditioners, lights, and water heaters based on environmental sensor data and user requests. Examples of the application to the car navigation system include inquiry text of a driver or a passenger, and a proposal of a stop place according to sensor data related to the environment around the car.

The text generation systems 11-13 may also be installed in amusement restaurants, theme park stores, and character goods shops to provide item recommendations. In this case, for example, the text generation apparatuses 201 to 203 may take an output mode in which answer text is spoken from a character or an avatar displayed on the display unit 26, or audio is output from a communication robot (i.e., the main body of the text generation apparatuses 201 and 203 or the user terminal 4). In addition, in this case, a dialogue including a specific tone of a character or an avatar and a word disposition may be used as training data for fine tuning of a large language model. Through the learning, the text generation apparatuses 201 to 203 can output the answer text of the tone of the character or the avatar and the word disposition.

Further, in each of the above-described embodiments, the answer text output from the large language model is presented to the user 5 as it is, but the text generation apparatuses 201 to 203 may edit the answer text output from the large language model before output. For example, when there is a need to include a specific item or a sales promotion of a specific manufacturer in the item proposal, the text generation unit 215 may inject a promotional sentence related to the specific item or the sales promotion of the specific manufacturer by RAG (Retrieval-Augmented Generation) to the answer text output from the large language model. Alternatively, the prompt generation unit 214 may incorporate content related to a specific item or a sales promotion of a specific manufacturer into the prompt. Note that the method of editing the prompt or the answer text is not limited to this example.

Further, in the first embodiment and the third embodiment described above, the various sensors 31 to 33 have been described as being installed in a store or the like in which the text generation systems 11 and 13 are used in order to measure the environment around the user 5 that is the providing destination of the answer text. However, the acquisition destination of the sensor data is not limited to the various sensors 31 to 33. For example, the sensor data may be wind speed, temperature, humidity, weather forecast information, or the like of a region including a store in which the text generation system 11 that can be acquired by the text generation apparatus 201,203 via the Internet or the like is provided.

Further, in each of the above-described embodiments, an example has been described in which the text generation unit 215 generates answer text to the inquiry text by inputting the prompt generated by the prompt generation unit 214 into the large language model, but the method of generating the answer text is not limited thereto. For example, other generative AI may be employed instead of a large language model.

As described above, according to the first to third embodiments, it is possible to provide an information processing apparatus and method that can obtain answer text reflecting environmental information based on data obtained from a sensor with respect to inquiry text.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A shopping terminal that is used in a store, comprising:
an input device;
an interface circuit connectable to one or more sensors located outside or inside the store;
a display;
a memory; and
a processor configured to execute a program that is stored in the memory to perform the steps of:
acquiring sensor data representative of environmental conditions from the sensors through the interface circuit,
acquiring first text that is input through the input device,
converting each of the sensor data into second text,
generating a prompt using the first and second text,
inputting the prompt to a computer model, which generates in response thereto third text that promotes an item sold in the store, wherein the computer model is a large language model that has learned relationships and connections between human perceptions under different environmental conditions, and data of items sold in the store, and
controlling the display to display the third text.

2. The shopping terminal according to claim 1, wherein
converting includes classifying each of the sensor data into a predetermined number of classes, each of which is associated with the corresponding second text.

3. The shopping terminal according to claim 2, wherein
the memory stores first data in which each of the classes is associated with the corresponding second text, and
converting includes referring to the first data when classifying each of the sensor data.

4. The shopping terminal according to claim 3, wherein
each of the sensor data indicates a value and is classified into the predetermined number of classes using one or more threshold values.

5. The shopping terminal according to claim 4, wherein
the sensors include a wind speed sensor, a temperature sensor, and a humidity sensor.

6. The shopping terminal according to claim 3, wherein
each of the sensor data is classified into the predetermined number of classes using the computer model, wherein the large language model of the computer model has also learned relationships and connections between sensor data representative of environmental conditions and multiple classes corresponding to human perception under different environmental conditions.

7. The shopping terminal according to claim 3, wherein
one of the sensor data is an image, and
converting includes performing an object recognition on the image and obtaining the second text corresponding to a result of the object recognition.

8. The shopping terminal according to claim 7, wherein
the sensors include a camera attached to the shopping terminal.

9. A method performed by a shopping terminal that is used in a store, the method comprising:
acquiring sensor data representative of environmental conditions from one or more sensors located outside or inside the store;
acquiring first text that is input through an input device;
converting each of the sensor data into second text;
generating a prompt using the first and second text;
inputting the prompt to a computer model, which generates in response thereto third text that promotes an item sold in the store, wherein the computer model is a large language model that has learned relationships and connections between human perceptions under different environmental conditions, and data of items sold in the store; and
displaying the third text.

10. The method according to claim 9, wherein
converting includes classifying each of the sensor data into a predetermined number of classes, each of which is associated with the corresponding second text.

11. The method according to claim 10, further comprising:
storing, in a memory, first data in which each of the classes is associated with the corresponding second text, wherein
converting includes referring to the first data when classifying each of the sensor data.

12. The method according to claim 11, wherein
each of the sensor data indicates a value and is classified into the predetermined number of classes using one or more threshold values.

13. The method according to claim 12, wherein
the sensors include a wind speed sensor, a temperature sensor, and a humidity sensor.

14. The method according to claim 11, wherein
each of the sensor data is classified into the predetermined number of classes using the computer model, wherein the large language model of the computer model has also learned relationships and connections between sensor data representative of environmental conditions and multiple classes corresponding to human perception under different environmental conditions.

15. The method according to claim 11, wherein
one of the sensor data is an image, and
converting includes performing an object recognition on the image and obtaining the second text corresponding to a result of the object recognition.

16. The method according to claim 15, wherein
the sensors include a camera attached to the shopping terminal.

17. A non-transitory computer readable medium storing a program causing a computer to execute a method comprising:
acquiring sensor data representative of environmental conditions from one or more sensors located outside or inside the store;
acquiring first text that is input through an input device;
converting each of the sensor data into second text;
generating a prompt using the first and second text;
inputting the prompt to a computer model, which generates in response thereto third text that promotes an item sold in the store, wherein the computer model is a large language model that has learned relationships and connections between human perceptions under different environmental conditions, and data of items sold in the store; and
displaying the third text.

18. The computer readable medium according to claim 17, wherein
converting includes classifying each of the sensor data into a predetermined number of classes, each of which is associated with the corresponding second text.

19. The computer readable medium according to claim 18, wherein
the method further comprises storing, in a memory, first data in which each of the classes is associated with the corresponding second text, and
converting includes referring to the first data when classifying each of the sensor data.

20. The computer readable medium according to claim 19, wherein
each of the sensor data indicates a value and is classified into the predetermined number of classes using one or more threshold values.
